(19) United States
(12) Patent Application Publication
(10) Pub. No.: US 2006/0034993 A1
(43) Pub. Date: Feb. 16, 2006

(54) Compositions for improved mouthfeel in reduced-sugar or sugar-free foodstuffs and associated methods and articles therefrom

(76) Inventor: Katrin Saelzer, Grosskrotzenburg (DE)

Correspondence Address: PROPAT, L.L.C., 425-C SOUTH SHARON AMITY ROAD, CHARLOTTE, NC, 28211-2841, US

(21) Appl. No.: 10/915,035

(22) Filed: Aug. 10, 2004

(51) Int. Cl. A23L 1/236

(52) U.S. Cl. 426/548

(57) ABSTRACT

The present invention provides texturizing compositions imparting advantageous organoleptic properties to reduced-sugar and sugar-free foodstuffs. The texturizing compositions generally include a mixture of tagatose and at least one long chain carbohydrate. The texturizing compositions have a synergistic effect on the organoleptic properties of the resulting foodstuffs, particularly mouthfeel. Accordingly, lesser amounts of the texturizing compositions may be incorporated into foodstuffs.

### FIELD OF THE INVENTION

The present invention generally relates to reduced calorie foodstuffs. More particularly, the present invention relates to texturizing compositions which may be included within reduced calorie foodstuffs to provide advantageous organoleptic properties.

### BACKGROUND OF THE INVENTION

Consumers are increasingly turning to healthier, reduced-calorie diets, primarily due to the increasing level of obesity and related rise in severe health problems. To reduce their caloric intake, consumers have generally turned to reduced fat foods. However, reduced-carbohydrate diets, i.e. diets that reduce or eliminate the consumption of simple carbohydrates such as mono- or disaccharides, are beginning to gain attention. A growing body of evidence indicates that the consumption of mono- or disaccharides, such as sucrose or glucose, may be problematic due to their high glycemic index. Accordingly, a need exists leads to reduce or eliminate mono- or di-saccharides, such as sugar or glucose, from foodstuffs.

Unfortunately, such mono- and di-saccharides play an important role in the organoleptic properties of foodstuffs. Sweetness, thickness and mouthfeel are three particular taste properties that are typically detrimentally affected by the reduction of mono- and di-saccharides.

Artificial sweeteners, such as acesulfame-K and saccharine, are widely known to impart sweetness to reduced-sugar or sugar-free foods. Consumers typically indicate that artificial sweeteners alone provide inadequate thickness and mouthfeel to reduced-sugar or sugar-free products, however.

Conventional sugar-free beverages are generally perceived as “thin” or “watery,” for example. Dairy products with no added sugar are typically noted to be “blunt”, “chalky” or “low in viscosity.” Condiment sauces without added sugar are perceived as “thin” or “lacking in mouthfeel.”

Taste quality remains one of the most important decision criterions for consumers, regardless of any caloric reduction. Consumers are generally unwilling to accept any compromise within the taste quality of reduced calorie foodstuffs. Consequently, many attempts have be made to overcome the lack of mouthfeel within reduced calorie foodstuffs.

F. M. Ward recommends using hydrocolloids as texturizing agents. Ward further notes the use of inulin, oligofructose or polydextrose as a source of dietary fiber to improve taste and mouthfeel of nutraceutical beverages. (Florian M. Ward, William H. Hanaway, Drink Technology & Marketing, March 2004, pg 7-9)

Barnhoon notes that carbohydrate fibers, such as beta-glucans, polydextrose, inulin or oligofructose, may be used in food to improve the taste and mouthfeel of food. Barnhoorn further discloses that long chain carbohydrates, especially glucans and fructans, have beneficial effects on colonic health, especially with regard to the large intestine. (R. Barnhoorn, International Food Ingredients, 2003 (3) p 34, 36, 38)

Franck reports a taste and mouthfeel enhancing effect for soluble fibers, inulin and oligofructose that helps overcome the lack of creaminess in low-fat foods. (Franck, British Journal of Nutrition (2002), 87(2), p 287-291).

De Soete discloses the use of fructan and/or polydextrose within dairy powders to improve mouthfeel and texture in EP 0821 885. Fructo-oligosaccharides and polydextrose are more particularly used as a fat replacer in various dairy products.

Aria technical literature notes the positive effects of around 1% of tagatose on the mouthfeel of beverages and dairy products. A positive effect on the creaminess of low-fat food and dairy products including tagatose is also reported. Arla further discloses the low calorie level and non-carcinogenic effect of tagatose compared to other carbohydrates.

Anderson indicates a taste improvement in low calorie food, especially in reduced-sugar or sugar-free beverages, by combining tagatose with high intensity sweeteners. Synergistic effects of these combinations on the sweetness intensity and sweet taste quality are also reported. (WO 99/34689).

Jager describes synergistic effects of indigestible oligosaccharides and high intensity sweeteners with regard to an enhanced sweetness intensity and an improved sweet taste in US 2003/0077369 A1 and EP 0 946 112.

Lee describes the beneficial effects of combinations of tagatose with sugar alcohols, such as erythritol, on taste profile of sugar-free and low-sugar beverages and food products in US 02/0197371 and WO 02/87358.

Consequently, tagatose, polydextrose, maltodextrin, inulin, oligofructose and the like are known individually for use in food products. Unfortunately, each of these substances still has a calorie value of about 1.0 to 1.5 kcal/g, and they thus contribute to the overall calorie value of the food. Also, these components can introduce other undesirable taste properties into the foodstuff, such as sliminess, chalky texture, gritty mouthfeel, astringency or teeth covering characteristics.

Accordingly, a need remains in the art to further reduce the calorie value of reduced-sugar or sugar-free foodstuffs. In addition, a need remains for reduced-sugar and sugar-free foodstuffs having improved mouthfeel and thickness without significant sacrifice to the remaining organoleptic properties.

### BRIEF SUMMARY OF THE INVENTION

The present invention provides reduced-sugar or sugar-free foodstuffs having improved mouthfeel, without significant sacrifice to the overall organoleptic properties of the resulting product. In advantageous embodiments, improved organoleptic properties, particularly improved mouthfeel, are provided for reduced-sugar or sugar-free foodstuffs in comparison to many conventional reduced-sugar or sugar-free compositions. In especially beneficial aspects of the invention, a further calorie reduction can be achieved by using the texturizing compositions of the invention within reduced sugar or sugar-free foodstuffs, rather than a conventional mouthfeel enhancer. More particularly, the texturizing compositions may beneficially be added in reduced amounts in comparison to a conventional mouthfeel enhancer, yet can provide at least as good mouthfeel to the resulting foodstuffs, or even better.

As used herein, the term “reduced-sugar” or “sugar-free” means foodstuffs having a reduced number calories from or reduced amount of added mono- or di-saccharides compared with its full-calorie or full-sugar counterpart. The term “full-calorie” or “full-sugar” as used herein refers to foodstuffs using only mono- or di-saccharides, such as glucose, fructose, saccharose, liquid sugar, inverted sugar syrup, HFCS, glucose syrup, maltose syrup, maple syrup, agave syrup or honey, to sweeten and texturize.

As used herein, the term “taste” refers to the sum of all organoleptic characteristics perceived in the mouth, nose and oral cavity during eating, chewing, sucking or swallowing the product. Exemplary organoleptic characteristics include sweetness, acidity, bitterness, saltiness, astringency, flavor, and mouthfeel. The term “mouthfeel” as used herein describes all tactile observations related with the texture and sensation of texture in the mouth, including creaminess, body, thickness, perceived viscosity and perceived temperature.

The present invention is directed to texturizing compositions that include an effective amount of tagatose, along with an effective amount of at least one long chain carbohydrate. The texturizing compositions of the invention provide a mouthfeel to foodstuffs that is superior in comparison to the mouthfeel induced within foodstuffs incorporating tagatose or long chain carbohydrate alone.

The present invention is further directed to foodstuffs incorporating the texturizing compositions of the invention, as well as methods by which to form the texturizing compositions and associated foodstuffs.

Most surprisingly, the texturizing compositions exhibit a synergistic effect in improving the mouthfeel of reduced-sugar or sugar-free foods, in comparison to the use of the individual texturizing components alone. Foodstuffs incorporating the texturizing compositions thus exhibit an overall taste profile that is superior to foods including the individual texturizing components alone. Consequently, lesser amounts of the texturizing compositions may be incorporated into foodstuffs in comparison to the amounts required for the individual texturizing components alone.

### DETAILED DESCRIPTION OF THE INVENTION

Texturizing compositions in accordance with the invention generally include tagatose and at least one long chain carbohydrate.

Tagatose as used herein means D-tagatose or β-D-tagatose, the common name for a particular sugar enantiomer having the molecular formula C₆H₁₂O₆. Tagatose is commercially available as GAIO® tagatose from Arla Food Ingredients, Denmark. In alternative embodiments, Applicant hypothesizes that other undigestible sugars, particularly left-handed enantiomeric sugars such as L-tagatose, may be used in lieu of D-tagatose.

Tagatose may be included within the texturizing compositions in any amount effective in imparting suitable organoleptic properties to the resulting foodstuff. The tagatose is advantageously included within the present texturizing compositions in non-limiting exemplary amounts ranging from about 1 to 99 weight percent, based on the weight of the texturizing composition (“bowtc”), such as amounts ranging from about 10 to 90 weight percent (bowtc), specifically from about 25 to 75 weight percent (bowtc), and more specifically from about 45 to 55 weight percent (bowtc). It being understood that the total amount of tagatose and long chain carbohydrate within the texturizing composition equals 100 weight percent.

As noted above, the present texturizing compositions further include at least one long chain carbohydrate. As used herein, long chain carbohydrates are defined as carbohydrates that may contain any number of mono- or di-saccharide units greater than 2, such as from 2 to 60 saccharide units.

Applicant hypothesizes that a wide range of long chain carbohydrates may be suitable for use within the texturizing compositions, including any oligosaccharide or polysaccharides, i.e. any saccharide other than monosaccharides, such as fructose or glucose, or disaccharides, such as sucrose, maltose, cellobiose or lactose. Exemplary long chain carbohydrates include fructan carbohydrates (hereinafter “fructans”), glucan carbohydrates (hereinafter “glucans”), polysaccharides and the like, mixtures thereof and partial hydrolysates thereof.

In advantageous embodiments, the long chain carbohydrate is fructan. Fructans, which may also be referred to as fructoolioscaccharides, are well known in the art. Advantageous non-limiting exemplary fructooligosaccharides which may be included within the texturizing compositions include inulin, oligofructose, and mixtures thereof.

As used herein, inulin generally refers to a type of fructooligosaccharide having a degree of polymerization of from about 2 to 60 molecules, although inulin having a higher degree of polymerization may be useful, as well. Inulin may be derived from a number of sources, including chicory root. Oliogofructose is generally known in the art as an inulin fraction having a lower degree of polymerization, typically from about 2 to 9. Oligofructose is usually isolated from inulin by partial enzymatic hydrolysis, as known in the art. The term fructooligosaccharide is often used as a synonym for oligofructose or as a product similar to oligofructose which is produced via enzymatic conversion of sucrose.

In particularly advantageous embodiments, the fructan is inulin or oligofructose. Inulin and oligofructose are commercially available from Raffinerie Tirlemontoise s.a., Brussel as RAFTILIN® or RAFTILOSE® respectively. Fructooligosaccharides are commercially available from Cerestar as ACTILIGHT®.

As noted above, the long chain carbohydrate may also be a glucan. Non-limiting exemplary glucans include polydextrose, maltodextrin, beta-glucans and mixtures thereof. In particularly advantageous embodiments, the glucan is polydextrose or maltodextrin. Polydextrose is commercially available as LITESSE® from Danisco. Maltodextrose is commercially available as STAR-DRI® from Tate & Lyle.

As further noted above, the long chain carbohydrate may also be a polysaccharide, and more specifically a natural or modified hydrocolloid. Non-limiting exemplary hydrocolloids include acacia gum, alkoxycellulose, carrageenan, cellulose gum, gellan gum, guar gum, gum arabic, karya gum, locust bean gum, modified starches, pectin, traganth gum, Xanthan gum and mixtures thereof. In especially beneficial embodiments, the polysaccharide is guar gum. Guar gum is commercially available from A. Wolf, Hamburg, Germany.

The long chain carbohydrate may also be derived from one or more complex sugars, such as galactose, xylose, arabinose or mannose. Non-limiting exemplary long chain carbohydrates derived from such complex sugars include xylo-oligosaccharides, galacto-oligosaccharides, galactomannans, xylomannans, arabinogalactans, arabinoxylans, chitosan, and mixtures thereof.

The long chain carbohydrate may be included within the texturizing compositions in any amount effective in imparting suitable organoleptic properties to the resulting foodstuff. The long chain carbohydrate is advantageously included within the texturizing compositions in non-limiting exemplary amounts ranging from about 1 to 99 weight percent (“bowtc”), such as amounts ranging from about 10 to 90 weight percent (bowtc), particularly from about 25 to 75 weight percent (bowtc), and more specifically from about 45 to 55 weight percent (bowtc). It being understood that the total amount of tagatose and long chain carbohydrate combined within the texturizing composition equals 100 weight percent (bowtc).

Considered on a weight ratio basis, the tagatose and long chain carbohydrate may be present within the texturizing composition in exemplary weight ratios ranging from about 1:10 to 10:1, such as weight ratios ranging from about 1:3 to 3:1, and more particularly in weight ratios of from about 1:2 to 2:1.

The texturizing compositions of the invention have been found to compensate for the lack of mouthfeel in reduced-sugar or sugar-free foodstuffs. Consequently, the foodstuff is typically either sugar-free or has a reduced sugar content in comparison to conventional full-sugar foods. The texturizing composition is less sweet compared to sugar or other mono- or di-saccharides normally used to sweeten food, however. Additional non-caloric sweeteners may thus be added to adjust the sweetness intensity.

In advantageous embodiments of the invention, the additional non-caloric sweetener is a high intensity sweetener. Exemplary high intensity sweeteners include acesulfame-K, aspartame, acesulfame-aspartame salt, cyclamate (mostly as Na-salt), saccharine (mostly as Na-salt), sucralose, NHDC, thaumatin, stevioside, neotame, brazzein, and mixtures thereof.

In particularly beneficial aspects of such embodiments, combinations of high intensity sweeteners may be used, such as combinations of two, three or four high intensity sweeteners selected from the group of acesulfame K, aspartame, sucralose, neotame, cyclamate and saccharine. Preferred high intensity sweetener mixtures for use in the present invention include acesulfame K/aspartame mixtures, acesulfame K/sucralose mixtures, acesulfame K/aspartame/sucralose mixtures and acesulfame K/neotame mixtures.

Persons skilled in the art can readily determine suitable amounts, combinations and weight ratios of high intensity sweeteners or high intensity sweetener combinations necessary to achieve a particular sweetness intensity and taste profile for a given food application.

Sugars and caloric sweeteners which may be present within reduced-sugar foodstuffs in accordance with the invention include glucose, fructose, saccharose, liquid sugar, inverted sugar, high fructose corn syrup (HFCS), and mixtures thereof.

Persons skilled in the art can similarly readily determine suitable amounts, combinations and weight ratios of sugars or caloric sweeteners necessary to achieve a particular sweetness intensity and taste profile for a given reduced-sugar food application.

The present texturizing compositions may advantageously be incorporated into any liquid or semi-soft foodstuff or food product or any solid foodstuff or food product formed from more than one component. Non-limiting exemplary foodstuffs include to various beverages, dairy products, desserts, fruit preparations, confectionary, and sweetening preparations. Exemplary beverages include carbonated and non-carbonated soft drinks, fruit juice based drinks, alcoholic- and non-alcoholic beverages, hot beverages (tea and coffee: fresh brewed, instant or sold ready-to-drink), fermented and non fermented dairy based drinks, powdered beverages, beverage concentrates or frozen beverages. Exemplary dairy products include yogurt, flavoured milk drinks, ice cream and smoothies. Exemplary desserts include both instant or ready-to-eat desserts. Exemplary fruit preparations include jams, jellies and marmalade. Exemplary confectioneries include soft or chewy candy and chocolate. Exemplary sweetening preparations include sauces, dressings and solid compositions used to sweeten food. Exemplary solid sweetening preparations include table top sweeteners in tablet, spoonable, sachet or liquid forms.

The texturizing compositions can be advantageously present within the foodstuff in any amount effective in imparting beneficial organoleptic properties to the resulting foodstuff. The texturizing compositions may be included within foodstuffs in non-limiting exemplary amounts ranging from about 0.01 to 5.0 weight percent, based on weight of the foodstuff (“bowfs”). In advantageous embodiments, the texturizing compositions can be present in foodstuffs in amounts ranging from about 0.10 to 2.0 weight percent (bowfs), and in particular from about 0.5 to 1.0 weight percent (bowfs).

The texturizing compositions and foodstuffs in accordance with the invention are formed by simply mixing the various components together. For example, the texturizing compositions are formed by either (a) combining the tagatose and at least one long chain carbohydrate together and mixing or (b) by adding the tagatose and at least one long chain carbohydrate separately to the foodstuff and then mixing. The mixing process employed may be any suitable mixing technique known in the food industry. The mixing may be done with either dry products or with solutions of the tagatose and/or at least one long chain carbohydrate and/or foodstuff, or combinations thereof.

In advantageous embodiments incorporating non-caloric sweeteners, such as high intensity sweeteners, the non-caloric sweetener may be introduced into the foodstuff either separately or in the form of a pre-blended composition that includes the texturizing composition.

Quite unexpectedly, Applicant found that the texturizing compositions impart both a quantitative and qualitative synergetic effect in terms of mouthfeel and body in reduced-sugar or sugar-free foods. Therefore, a significantly reduced amount of the texturizing compositions can be incorporated into foodstuffs to produce organoleptic effects comparable to foodstuffs containing the individual texturizing components alone (such as tagatose or oligofructose alone). More particularly, the texturizing compositions allow the total amount of tagatose and/or long chain carbohydrates in the foodstuff to be reduced by 20% or more, such as by 30% or more, and more preferably by 50% or more, while retaining the same or substantially the same mouthfeel and/or body within the resulting reduced-sugar or sugar-free foodstuff in comparison to the use of the individual texturizing components alone.

Furthermore, foodstuffs incorporating approximately the same amounts of the texturizing compositions as are used with the individual texturizing components exhibit superior organoleptic properties than heretofore known within reduced-sugar or sugar-free foodstuffs. Stated differently, foodstuffs incorporating the texturizing compositions in the amounts normally used with the individual texturizing components alone actually have a better taste than foodstuffs incorporating either tagatose or long chain carbohydrate alone.

In addition to economic advantages, an essential benefit of the texturizing composition is that the total amount of tagatose and long chain carbohydrates in the foodstuff can be significantly reduced to produce the same level of mouthfeel, particularly thickness, body and perceived viscosity. This reduction in texturizing components results in a significant reduction in the caloric value and carbohydrate content of the resutling foodstuff. Additionally, due to the overall reduced amount of texturizers, any negative side effect on taste or mouthfeel caused by any of the individual texturizing componentss, such as sliminess, chalky texture, gritty mouthfeel, astringency or teeth covering characteristics, are minimised. This effect enhances the overall taste quality even further.

A further advantage of the texturizing compositions is the reduced amount of long chain carbohydrates consumed by the end-user. Long chain carbohydrates are known to potentially cause digestive problems and flatulence.

The invention is further illustrated by the following, non-limiting, examples.

### EXAMPLES

### Comparative Examples 1-3 and Examples 1-3

Sugar-free powdered beverage formulations according to Table 1 were prepared, diluted to a drinkable beverage immediately before tasting and described by a sensory trained panel in comparison to a control sample without texturizing agents using consensus method. Additionally a ranking in terms of best, thickest mouthfeel was given by the panel, with “1” meaning best in mouthfeel and higher numbers indicating lower mouthfeel. Unless indicated otherwise, all concentrations given in the examples below are in g/l of ready-to-drink beverage.

TABLE 1
Beverage Formulations Including Tagatose and Oligofructose

| | Comp. | Comp. | Comp. | | | |
|---|---|---|---|---|---|---|
| | Ex. 1 | Ex. 2 | Ex. 3 | Ex. 1 | Ex. 2 | Ex. 3 |
| Dry flavour base (g/l) | 4.2 | 4.2 | 4.2 | 4.2 | 4.2 | 4.2 |
| Citric acid (g/l) | 3.25 | 3.25 | 3.25 | 3.25 | 3.25 | 3.25 |
| Acesulfame K (g/l) | 0.126 | 0.124 | 0.124 | 0.125 | 0.124 | 0.122 |
| Aspartame (g/l) | 0.252 | 0.241 | 0.248 | 0.250 | 0.2483 | 0.245 |
| Tagatose (g/l) | | 5.0 | | 1.0 | 1.5 | 2.0 |
| Oligofructose (g/l) | | | 5.0 | 1.0 | 1.5 | 2.0 |
| Sensory description | | Equisweet to | Equisweet with | Equisweet, | Equisweet, | Equisweet, |
| | | control, no | control, higher | mouthfeel | thick, full | very good, |
| | | significant | acidity, slightly | slightly | mouthfeel | thick |
| | | difference in | thicker, higher | increased | | mouthfeel |
| | | mouthfeel to | in mouthfeel as | compared to | | |
| | | Comp. Ex. 1 | Comp. Ex. 1 | Comp. Ex. 1 | | |
| Ranking | 5 | 5 | 2 | 4 | 3 | 1 |

As indicated in Table 1 about 4.0 g/l of the texturizing composition provided a higher mouthfeel compared to 5.0 g/l oligofructose or tagatose alone. Based on this, only approximately 3.5 g/l of the texturizing composition should be necessary to achieve the same improvement in mouthfeel compared to 5.0 g/l of oligofructose alone, indicating a quantitative synergy in terms of mouthfeel of around 30%.

### Comparative Examples 4-6 and Example 4

Sugar-free powdered beverage formulations incorporating mixtures of tagatose and maltodextrine were prepared and evaluated using the methods of Comparative Examples 1-3 and Examples 1-3. The formulations and results for Comparative Examples 4-6 and Example 4 are summarised in Table 2 below.

TABLE 2
Beverage Formulations Including Tagatose and Maltodextrine

| | Comp. | Comp. | Comp. | |
|---|---|---|---|---|
| | Ex. 4 | Ex. 5 | Ex. 6 | Ex. 4 |
| Dry flavour base | 4.2 | 4.2 | 4.2 | 4.2 |
| (g/l) | | | | |
| Citric acid | 3.25 | 3.25 | 3.25 | 3.25 |
| (g/l) | | | | |
| Acesulfame K | 0.126 | 0.124 | 0.125 | 0.125 |
| (g/l) | | | | |
| Aspartame | 0.252 | 0.241 | 0.249 | 0.249 |
| (g/l) | | | | |
| Tagatose | | 5.0 | | 2.5 |
| (g/l) | | | | |
| Maltodextrine | | | 5.0 | 2.5 |
| (g/l) | | | | |
| Sensory | | Equisweet to | Equisweet to | Equisweet, |
| description | | control, no | control, no | smoother as |
| | | significant | significant | control, thicker |
| | | difference in | difference in | in mouthfeel |
| | | mouthfeel to | mouthfeel to | compared to |
| | | Comp. Ex. 4 | Comp. Ex. 4 | Comp. Exs. |
| | | | | 4, 5 and 6 |
| Ranking | 3 | 2 | 2 | 1 |

As shown in Table 2, the addition of 5.0 g/l of either tagatose or maltodextrine alone gave rise to only a minimal shift in mouthfeel. A significantly improved mouthfeel was achieved when adding the same amount (i.e. 5.0 g/l) of a mixture of tagatose and maltodextrine, however,

### Comparative Examples 7-9 and Examples 5-9

Sugar-free powdered beverage formulations incorporating mixtures of tagatose and inulin were prepared and evaluated using the methods of Comparative Examples 1-3 and Examples 1-3. The formulations and results for Comparative Examples 7-9 and Examples 5-9 are summarised in Table 3 below.

TABLE 3
Beverage Formulations Including Tagatose and Inulin

| | Comp. | Comp. | Comp. | | | | | |
|---|---|---|---|---|---|---|---|---|
| | Ex. 7 | Ex. 8 | Ex. 9 | Ex. 5 | Ex. 6 | Ex. 7 | Ex. 8 | Ex. 9 |
| Dry flavour base (g/l) | 4.2 | 4.2 | 4.2 | 4.2 | 4.2 | 4.2 | 4.2 | 4.2 |
| Citric acid (g/l) | 3.25 | 3.25 | 3.25 | 3.25 | 3.25 | 3.25 | 3.25 | 3.25 |
| Acesulfame K (g/l) | 0.126 | 0.124 | 0.125 | 0.121 | 0.122 | 0.122 | 0.125 | 0.125 |
| Aspartame (g/l) | 0.252 | 0.241 | 0.249 | 0.242 | 0.244 | 0.244 | 0.249 | 0.249 |
| Tagatose (g/l) | | 5.0 | | 4.26 | 3.34 | 2.5 | 1.66 | 0.83 |
| Inulin (g/l) | | | 5.0 | 0.83 | 1.66 | 2.5 | 3.34 | 4.26 |
| Ranking | 5 | 5 | 4 | 3 | 1 | 1 | 2 | 3 |

As shown in Table 3, the synergistic improvement in the mouthfeel can be affected by the ratio of the texturizing components within the composition. For inulin-based texturizing compositions, weight ratios of from about 1:1 to 1:2 (inulin:tagatose) appear to provide the greatest amounts of synergy, although smaller synergistic effects are noted for other weight ratios, as well.

### Comparative Examples 10-13 and Example 10

Sugar-free powdered beverage formulations incorporating mixtures of tagatose and guar gum were prepared and evaluated using the methods of Comparative Examples 1-3 and Examples 1-3. The formulations and results for Comparative Examples 10-13 and Example 10 are summarised in Table 4 below.

TABLE 4
Beverage Formulations Including Tagatose and Guar Gum

| | Comp. | Comp. | Comp. | Comp. | |
|---|---|---|---|---|---|
| | Ex. 10 | Ex. 11 | Ex. 12 | Ex. 13 | Ex. 10 |
| Dry flavour base (g/l) | 4.2 | 4.2 | 4.2 | 4.2 | 4.2 |
| Citric acid (g/l) | 3.25 | 3.25 | 3.25 | 3.25 | 3.25 |
| Acesulfame K (g/l) | 0.126 | 0.124 | 0.126 | 0.126 | 0.126 |
| Aspartame (g/l) | 0.252 | 0.241 | 0.252 | 0.252 | 0.252 |
| Tagatose (g/l) | | 5.0 | | | 2.5 |
| Guar gum (g/l) | | | 0.2 | 0.5 | 0.1 |
| Sensory description | | Equisweet to | Equisweet, | Equisweet, | Equisweet, |
| | | control, no | thicker in | thicker in | smooth, thicker |
| | | significant | mouthfeel | mouthfeel than | mouthfeel than |
| | | difference in | than | Comp. Ex. 12, | Comp. Exs. 10 |
| | | mouthfeel to | control, | higher | to 12, perceived |
| | | Comp. Ex. 10 | smooth | perceived | viscosity close |
| | | | | viscosity | to Comp. Ex. 13 |
| Ranking | 4 | 3 | 2 | 1 | 1 |

As shown in Table 4, the addition of tagatose and guar gum in combination allows a reduction in the concentration of both ingredients of about 50% compared to the concentration required when the single ingredients are used alone. Quite surprisingly, the synergy provided by the texturizing compositions provides an enhanced effect on the mouthfeel and perceived viscosity of the beverage, regardless of the overall reduction in individual texturizing agents.

### Comparative Examples 14-16 and Example 11

Instant coffee formulations incorporating mixtures of tagatose and inulin were prepared and evaluated using the methods of Comparative Examples 1-3 and Examples 1-3. The sensory test was performed with diluted coffee at approximately 60° C. The formulations and results for Comparative Examples 14-16 and Example 11 are summarised in Table 3 below.

TABLE 5
Coffee Formulation Incorporating Tagatose and Inulin

| | Comp. | Comp. | Comp. | |
|---|---|---|---|---|
| | Ex. 14 | Ex. 15 | Ex. 16 | Ex. 11 |
| Instant | 8.0 | 8.0 | 8.0 | 8.0 |
| coffee (g/l) | | | | |
| Acesulfame | 0.063 | 0.0605 | 0.0625 | 0.0615 |
| K (g/l) | | | | |
| Aspartame | 0.126 | 0.1205 | 0.1245 | 0.122 |
| (g/l) | | | | |
| Tagatose | | 5.0 | | 2.5 |
| (g/l) | | | | |
| Inulin | | | 5.0 | 2.5 |
| (g/l) | | | | |
| Sensory | | Sweetness and | Equisweet, | Equisweet, |
| description | | mouthfeel very | slightly thicker | thicker in |
| | | similar to | mouthfeel | mouthfeel |
| | | Comp. Ex. 14 | than Comp. | compared to |
| | | | Exs. 14 and 15 | Comp. Exs. 14, |
| | | | | 15 and 16 |
| Ranking | 3 | 3 | 2 | 1 |

As shown in Table 5, even in hot beverages, such as coffee, the mixture of tagatose and inulin showed a synergistic improvement in mouthfeel compared to the texturizing agents used alone.

### Comparative Examples 17-19 and Example 12

Reduced-sugar, spicy curry formulations incorporating mixtures of tagatose and polydextrose were evaluated using the methods of Comparative Examples 1-3 and Examples 1-3. The formulations and results for Comparative Examples 17-19 and Example 12 are summarised in Table 6 below.

TABLE 6
Curry Sauce Incorporating Tagatose and Polydextrose

| | Comp. | Comp. | Comp. | |
|---|---|---|---|---|
| | Ex. 17 | Ex. 18 | Ex. 19 | Ex. 12 |
| Sugar | 220 | 220 | 220 | 220 |
| (g/l) | | | | |
| Acesulfame | 0.350 | 0.327 | 0.350 | 0.339 |
| K (g/l) | | | | |
| Sucralose | 0.110 | 0.100 | 0.110 | 0.106 |
| (g/l) | | | | |
| Tagatose | | 10.0 | | 5.0 |
| (g/l) | | | | |
| Polydextrose | | | 10.0 | 5.0 |
| (g/l) | | | | |
| Sensory | | Sweetness and | Sweetness and | Sweetness |
| description | | flavor | flavor | comparable, |
| | | comparable to | comparable, | milder |
| | | control, | thicker | in acidity, thick |
| | | smooth, | mouthfeel and | mouthfeel, |
| | | slightly thicker | higher | significantly |
| | | than Comp. | perceived | more than |
| | | Ex. 17 | viscosity | Comp. Exs. 18 |
| | | | | and 19 |
| Ranking | 4 | 3 | 2 | 1 |

As shown in Table 6, adding either tagatose or polydextrose alone to the reduced-sugar curry gives only a limited improvement in mouthfeel and viscosity. In contrast, a combination of both these of these texturizing agents, present in the same total amount, produced a significantly better mouthfeel. Accordingly, the synergistic effects of the texturizing compositions is noted for reduced-sugar formulations as well.

### Comparative Examples 20-22 and Example 13

The effect of tagatose and polydextrose on the mouthfeel of a strawberry flavored, low fat yogurt was evaluated using the methods of Comparative Examples 1-3 and Examples 1-3. The formulations and results for Comparative Examples 20-22 and Example 13 are summarised in Table 7 below.

TABLE 7
Low Fat Yogurt Formulation Incorporating Tagatose and Polydextrose

| | Comp. | Comp. | Comp. | |
|---|---|---|---|---|
| | Ex. 20 | Ex. 21 | Ex. 22 | Ex. 13 |
| Strawberry | 1.2 | 1.2 | 1.2 | 1.2 |
| flavor | | | | |
| (g/kg yogurt) | | | | |
| Natural color | 0.02 | 0.02 | 0.02 | 0.02 |
| (g/kg yogurt) | | | | |
| Acesulfame | 0.098 | 0.096 | 0.098 | 0.098 |
| K | | | | |
| (g/kg yogurt) | | | | |
| Aspartame | 0.200 | 0196 | 0.200 | 0.200 |
| (g/kg yogurt) | | | | |
| Tagatose | | 10.0 | | 5.0 |
| (g/kg yogurt) | | | | |
| Polydextrose | | | 10.0 | 5.0 |
| (g/kg yogurt) | | | | |
| Sensory | | Slightly | Thicker in | Thick and |
| description | | thicker, | mouthfeel than | creamy |
| | | smoother and | Comp. Ex. 21, | mouthfeel, |
| | | creamier than | slightly chalky | teeth covering |
| | | control, not as | and | effect lower |
| | | teeth covering | teeth covering | than in |
| | | as Comp. | | Comp. |
| | | Ex. 20 | | Ex. 22 |
| Ranking | 3 | 2 | 2 | 1 |

As shown in Table 7, the addition of tagatose alone to sugar-free, low fat yogurt gives only a slight improvement in mouthfeel. Similarly, polydextrose alone also yields only a slight improvement in mouthfeel. Polydextrose alone induces negative effects, as well, causing a teeth covering, chalky texture. In contrast, the addition of a mixture of tagatose and polydextrose imparts a significantly enhanced effect on mouthfeel and creaminess. As an added benefit, a lower concentration of both ingredients may be used within the texturizing compositions to achieve the desired effect in mouthfeel, thus any adverse effect on texture or taste from any individual component can be minimised.

Based on the foregoing, texturizing compositions according to this invention have been shown to improve the mouthfeel and body of reduced-sugar and sugar-free foodstuffs, so that products using the texturizing compositions can be made to taste like comparable full-sugar products. Surprising, around 30%, and potentially around 50% less, of the texturizing compositions may be used compared to the use of the individual components alone in achieving a given level of mouthfeel. Consequently, by using the texturizing compositions the added calories are minimised, due to both to its synergistic effects and additionally because of the low caloric value of the texturizing components.

Additional advantages, features and modifications will readily occur to those skilled in the art. Therefore, the invention in its broader aspects is not limited to the specific details and representative devices, shown and described herein. Accordingly, various modifications may be made without departing from the spirit or scope of the general inventive concept as defined by the appended claims and their equivalents.

As used herein and in the following claims, articles such as “the”, “a” and “an” can connote the singular or plural.

All documents referred to herein are specifically incorporated herein by reference in their entireties.

That which is claimed:

1. A texturizing composition comprising
an effective amount of tagatose and
an effective amount of a long chain carbohydrate comprising at least one oligosaccharide or polysaccharide.

2. A composition according to claim 1, wherein said tagatose is present in an amount ranging from about 1 to 99 weight percent, bowtc.

3. A composition according to claim 1, wherein said long chain carbohydrate is present in an amount ranging from about 1 to 99 weight percent, bowtc.

4. A composition according to claim 1, wherein said long chain carbohydrate comprises at least one member selected from the group consisting of fructans, glucans or polysaccharides.

5. A composition according to claim 1, wherein said long chain carbohydrate comprises at least one fructan selected from the group consisting of inulin and oligofructose.

6. A composition according to claim 1, wherein said long chain carbohydrate comprises at least one glucan selected from the group consisting of polydextrose, maltodextrin and beta-glucans.

7. A composition according to claim 1, wherein said long chain carbohydrate comprises a polysaccharide.

8. A composition according to claim 7, wherein said polysaccharide comprises at least one hydrocolloid selected from the group consisting of acacia gum, alkoxycellulose, carrageenan, cellulose gum, gellan gum, guar gum, gum arabic, karya gum, locust bean gum, modified starches, pectin, traganth gum, and Xanthan gum.

9. A composition according to claim 1, wherein said long chain carbohydrate is a fructan or glucan and said tagatose and said long chain carbohydrate are present in a weight ratio ranging from about 1:2 to 2:1.

10. A reduced calorie foodstuff comprising a texturizing composition,
said texturizing composition comprising
an effective amount of tagatose and
an effective amount of at least one long chain carbohydrate.

11. A foodstuff according to claim 10, wherein said texturizing composition is present within said foodstuff in an amount ranging from about 0.01 to 5.0 weight percent, bowfs.

12. A foodstuff according to claim 10, wherein said tagatose is present within said texturizing composition in an amount ranging from abut 1 to 99 weight percent, bowtc.

13. A foodstuff according to claim 10, wherein said long chain carbohydrate is present within said texturizing composition in an amount ranging from about 1 to 99 weight percent, bowtc.

14. A foodstuff according to claim 10, wherein said long chain carbohydrate comprises at least one member selected from the group consisting of fructans, glucans and polysaccharides.

15. A foodstuff according to claim 10, wherein the foodstuff further comprises at least one high intensity sweetener.

16. A foodstuff according to claim 10, wherein said high intensity sweetener comprises at least one member selected from the group consisting of acesulfame-K, aspartame, acesulfame-aspartame salt, cyclamate, saccharine, sucralose, NHDC, thaumatin, stevioside, neotame and brazzein.

17. A composition according to claim 16, wherein said high intensity sweetener comprises acesulfame k and aspartame.

18. A composition according to claim 17, wherein said aspartame and acesulfame k are present in an approximately 2:1 weight ratio of aspartame to acesulfame k.

19. A composition according to claim 16, wherein said high intensity sweetener comprises acesulfame k and sucralose.

20. A composition according to claim 19, wherein said acesulfame K and sucralose are present in an approximately 3.5:1.0 to 3.0:1.0 weight ratio of acesulfame k to sucralose.

21. A foodstuff according to claim 10, wherein said foodstuff is a beverage, dairy product, dessert, fruit preparation, confectionary or sweetening preparation.

22. A method of preparing a reduced calorie foodstuff, said method comprising
providing a reduced-sugar or sugar-free foodstuff and
incorporating an effective amount of a texturizing composition comprising tagatose and at least one long chain carbohydrate.

23. A method according to claim 22, wherein said texturizing composition is present within said foodstuff in an amount ranging from about 0.01 to 5.0 weight percent, bowfs.

24. A method according to claim 22, wherein said long chain carbohydrate comprises at least one member selected from the group consisting of fructans, glucans or polysaccharides.

25. A method according to claim 22, further comprising incorporating at least one high intensity sweetener.
